(19) United States
(12) Patent Application Publication
(10) Pub. No.: US 2008/0130794 A1
(43) Pub. Date: Jun. 5, 2008

(54) METHOD FOR OPTIMUM THRESHOLD SELECTION OF TIME-OF-ARRIVAL ESTIMATORS

(76) Inventors: Chia-Chin Chong, Santa Clara, CA (US); Fujio Watanabe, Union City, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/949,152

(22) Filed: Dec. 3, 2007

Related U.S. Application Data
(60) Provisional application No. 60/868,526, filed on Dec. 4, 2006.

(51) Int. Cl. H04L 25/06

(52) U.S. Cl. 375/317

(57) ABSTRACT

The following invention relates to geolocation technology. In particular, the proposed method can be used to determine the optimum threshold value that minimizes the estimation error. The proposed method also allows the threshold value to be varied adaptively according to the signal-to-noise ratios (SNRs) under consideration. This is to ensure that the optimum threshold value is being selected under all channel conditions i.e., both line-of-sight (LOS) and non-LOS (NLOS) scenarios. Additionally, the proposed method is generic and system independent in which it can be applied to both coherent (e.g., match filter (MF)) and non-coherent receivers (e.g., energy detector (ED)).

### CROSS REFERENCE TO RELATED APPLICATIONS

The present application is related to and claims priority of U.S. provisional patent application Ser. No. 60/868,526, entitled “Method for Optimum Threshold Selection of Time-of-Arrival Estimators,” filed on Dec. 4, 2006. The disclosure of the provisional patent application is hereby incorporated by reference in its entirety.

### BACKGROUND OF THE INVENTION

1. Field of the Invention

The present invention relates to wireless communication. In particular, the present invention relates to estimating the time-of-arrival of a received signal.

2. Discussion of the Related Art

The need for accurate geolocation has become more acute in recent years, especially in a cluttered environment (e.g., inside a building, in an urban locale, or surrounded by foliage), where the Global Positioning System (GPS) is often inaccessible. Unreliable geolocation adversely affects the performance of many applications, e.g., in a commercial setting, tracking of inventory in a warehouse or on a cargo ship, and in a military setting, tracking of friendly forces. Because of its ability to resolve multipaths and to penetrate obstacles, ultra-wideband (UWB) technology offers great promise for achieving a high positioning accuracy in a cluttered environment.

Geolocation using UWB technology is discussed, for example, in (a) “Ultra-wideband precision asset location system,” by R. J. Fontana and S. J. Gunderson, in Proc. of IEEE Conf. on Ultra Wideband Systems and Technologies (UWBST), Baltimore, Md., May 2002, pp. 147-150; (b) “An ultra wideband TAG circuit transceiver architecture,” by L. Stoica, S. Tiuraniemi, A. Rabbachin, I Oppermann, in International Workshop on Ultra Wideband Systems. Joint UWBST and IWUWBS 2004, Kyoto, Japan, May 2004, pp. 258-262; (c) “Pseudo-random active UWB reflectors for accurate ranging,” by D. Dardari, in IEEE Commun. Lett., vol. 8, no. 10, pp. 608-610, October 2004; (d) “Localization via ultra-wideband radios: a look at positioning aspects for future sensor networks,” by S. Gezici, Z. Tian, G. B. Giannakis, H. Kobayashi, A. F. Molisch, H. V. Poor, and Z. Sahinoglu, in IEEE Signal Processing Mag., vol. 22, pp. 70-84, July 2005; and (d) “Analysis of wireless geolocation in a non-line-of-sight environment,” by Y. Qi, H. Kobayashi, and H. Suda, in IEEE Trans. Wireless Commun., vol. 5, no. 3, pp. 672-681, March 2006.

The accuracy of a position estimation is affected by noise, multipath components (MPCs), and different propagation speeds through obstacles in non-line-of-sight (NLOS) environments. Many positioning techniques are based on estimating a time-of-arrival (TOA) over the first path. TOA estimation is discussed, for example, in (a) “Performance of UWB position estimation based on time-of-arrival measurements,” by K. Yu and I. Oppermann, in International Workshop on Ultra Wideband Systems. Joint UWBST and IWUWBS 2004., Kyoto, Japan, May 2004, pp. 400-404; (b) “Non-coherent TOA estimation in IR-UWB systems with different signal waveforms,” by I. Guvenc, Z. Sahinoglu, A. F. Molisch, and P. Orlik, in Proc. IEEE Int. Workshop on Ultrawideband Networks (UWBNETS), Boston, Mass., October 2005, pp. 245-251; (c) “Improved lower bounds on time-of-arrival estimation error in realistic UWB channels,” by D. Dardari, C.-C. Chong, and M. Z. Win, in Proc. IEEE Int. Conf. on Ultra-Wideband (ICUWB), Waltham, Mass., September 2006, pp. 531-537; and (d) “Threshold-based time-of-arrival estimators in UWB dense multipath channels,” D. Dardari, C.-C. Chong, and M. Z. Win, in IEEE Trans. Commun., to be published in 2008.

Generally, the signal strength contributed by the portion of the signal corresponding to a first arriving path is not the strongest, thereby making a TOA estimation challenging in a dense multipath channel or in a NLOS condition. The term “strongest path” in this detailed description refers to the portion of the signal that appears least attenuated. A TOA estimation technique that estimates based on the strongest path, or which adopts the TOA of the strongest path signal as the estimated TOA, is therefore inaccurate. Estimating TOA in a multipath environment is very similar to channel estimation technique, as both the channel amplitudes and the TOAs may be estimated using, for example, a maximum likelihood (ML) approach. Channel estimation technique are described, for example, in (a) “Characterization of ultra-wide bandwidth wireless indoor communications channel: A communication theoretic view,” M. Z. Win and R. A. Scholtz, in IEEE J. Select. Areas Commun., vol. 20, no. 9, pp. 1613-1627, December 2002; and (b) “Channel estimation for ultra-wideband communications,” V. Lottici, A. D'Andrea, and U. Mengali, in IEEE J. Select. Areas Commun., vol. 20, no. 9, pp. 1638-1645, December 2002. However, such techniques are very complex, and thus they are expensive to implement and increase the power consumption of the device. The article, “Ranging in a dense multipath environment using an UWB radio link,” by J.-Y. Lee and R. A. Scholtz, in IEEE J. Select. Areas Commun., vol. 20, no. 9, pp. 1677-1683, December 2002, describes a generalized ML-based TOA estimation being applied to UWB technology. In that paper, the strongest path is assumed to be perfectly locked and the relative delay of the first path is estimated.

TOA estimation can be accomplished using a conventional correlation estimator, in which the received signal is correlated with a template of the transmitted signal. The correlation is sometimes carried out in a match filter (MF). The delay of the first detected maximum or local peak at the correlator output is adopted as the TOA. See, for example, Detection, Estimation, and Modulation Theory, by H. L. Van Trees, first ed., John Wiley & Sons, Inc., publisher, 1968. In an additive white Gaussian noise (AWGN) channel, this conventional correlation estimator is known to be asymptotically efficient, since it achieves the Cramer-Rao lower bound (CRLB) at large signal-to-noise ratios (SNRs).

Estimators based on energy detection (ED) are also widely used because they can be implemented simply at sub-Nyquist sampling rates. ED-based estimators are particularly attractive in low-complexity, low-cost, low-power consumption positioning applications, where a non-coherent technique can be used. ED-based estimators are described, for example, in (a) “Threshold-based TOA estimation for impulse radio UWB systems,” by I. Guvenc and Z. Sahinoglu, in Proc. IEEE Int. Conf. on Utra-Wideband (ICU), Zurich, Switzerland, September 2005, pp. 420-425; (b) “Synchronization, TOA and position estimation for low-complexity LDR UWB devices,” by P. Cheong, A. Rabbachin, J. Montillet, K. Yu, and I. Oppermann, in Proc. IEEE Int. Conf. on Utra-Wideband (ICU), Zurich, Switzerland, September 2005, pp. 480-484; (c) “Non-coherent energy collection approach for TOA estimation in UWB systems,” by A. Rabbachin, J. P. Montillet, P. Cheong, A. Rabbachin, G. T. F. de Abreu, and I. Oppermann, in Proc. Int. Symp. on Telecommunications (IST), Shiraz, Iran, September 2005; and (d) “ML time-of-arrival estimation based on low complexity UWB energy detection,” by A. Rabbachin, I. Oppermann, and B. Denis, in Proc. IEEE Int. Conf. on Ultra-Wideband (ICUWB), Waltham, Mass., September 2006, pp. 599-604. The techniques discussed in these papers are, however, very preliminaries. For example, in (a) above, a semi-analytical approach aided by simulations is disclosed.

In the presence of multipath, or at a low SNR, MF and ED estimators may produce adjacent peaks with similar heights that result from noise, multipath, and pulse side lobes, all of which makes selecting the correct peak difficult, and thus degrades ranging accuracy. Under these environmental conditions, estimation performance is dominated by large errors (also called “global errors”) which may be even greater than the width of the transmitted pulse. As a consequence, the TOA estimate tends to be biased and the corresponding mean-square-error (MSE) is large at low SNRs. This behavior is known in non-linear estimation as a thresholding phenomenon. (See, for example, the article “Time delay estimation via cross-correlation in the presence of large estimation errors,” by J. P. lanniello, in IEEE Trans. Acoust., Speech, Signal Processing, vol. ASSP-30, no. 6, pp. 998-1003, December 1982). In such a situation, the performance of the conventional correlation estimator, or any other estimation scheme, may be inferior to that predicted by an asymptotic bound (e.g., CRLB). At a very high SNR, or with an exceedingly long observation time, the effect of large errors can be made negligible. Under such a condition, the estimation performance is dominated by small errors that approximate the transmitted pulse width and may be well accounted for by an asymptotic bound. However, such a condition cannot in general be met in practice. Typically, a UWB system operates in a multipath environment at low SNRs. Most TOA estimation techniques reported in the literature are system-dependent (e.g., correlation-based estimators for coherent system (e.g., MF) or threshold-based estimators for non-coherent system (e.g., ED)). Further, threshold-based estimation techniques in non-coherent receivers typically use a fixed threshold value, without regard to channel conditions.

A simple technique that may be used in a harsh propagation environment for detecting the portion of the signal corresponding to a first arriving path is to compare the MF or ED estimator output values with a threshold whose value has to be optimized according to operating conditions (e.g., SNR). The threshold-based approach is attractive in applications using low-cost, battery-powered devices (e.g., in wireless sensor networks), as such applications are sensitive to complexity and computational constraints. Most threshold-based TOA estimators work efficiently only under a high SNR condition, or after a long observation time (e.g., after observing a long preamble). At a low SNR, or after a short observation time (e.g., after observing a short preamble), these estimators tend to be biased and the corresponding MSE increases. In addition, complex channel estimators do not always correspond to good TOA estimators. Indeed, the article “ML time delay estimation in a multipath channel,” by H. Saarnisaari, in International Symposium on Spread Spectrum Techniques and Applications, Mainz, Germany, September 1996, pp. 1007-1011, shows that, for certain SNR ranges, the ML channel estimator performs poorly in estimating the TOA of the first arriving path, as compared to the threshold-based TOA estimator. A similar conclusion based on empirical results is reported in “Time of arrival estimation for UWB localizers in realistic environments,” by C. Falsi, D. Dardari, L. Mucchi, and M. Z. Win, in EURASIP J. Appl. Signal Processing, vol. 2006, pp. 1-13. Therefore, performance characterization for a threshold-based estimator is important.

Conventionally, approaches for estimating the TOA generally use an interference or inter-path cancellation technique, which are based on recognizing the shape of the band-limited transmitted pulse. (See, for example, “On the determination of the position of extrema of sampled correlators,” by R. Moddemeijer, in IEEE Trans. Acoust., Speech, Signal Processing, vol. 39, no. 1, pp. 216-291, January 1991.). This approach is robust, but does not lead to significant improvement in the initial TOA estimation. The article “Subspace-based estimation of time delays and Doppler shift,” by A. Jakobsson, A. L. Swindlehurst, and P. Stoica, in IEEE Trans. Acoust., Speech, Signal Processing, vol. 46, no. 9, pp. 2472-2483, September 1998, describes a complex subspace-based approach, which requires generating several correlation matrices and their inverses, and performs a large number of matrix multiplications to achieve a TOA estimate. Such a technique is also unsuitable in static or slowly moving channels. See, for example, “Advanced receivers for CDMA systems,” by M. Latva-aho, in Acta Uniersitatis Ouluensis, C125, pp. 179. Similarly, the article “Superresolution of multipath delay profiles measured by PN correlation method,” by T. Manabe and H. Takai, in IEEE Trans. Antennas Propagat., vol. 40, no. 5, pp. 500-509, May. 1992, discloses eigenvector decomposition as a form of subspace technique. This TOA estimation approach requires complex calculations of the eigenvectors of the channel correlation matrix.

In the prior art, TOA estimation performance is evaluated using asymptotic analysis, simulations or measurements. See, e.g., (a) “Cramer-Rao lower bounds for the time delay estimation of UWB signals,” by J. Zhang, R. A. Kennedy, and T. D. Abhayapala, in Proc. IEEE Int. Conf. on Commun., vol. 6, Paris, France, May 2004, pp. 3424-3428; and (b) “Pulse detection algorithm for line-of-sight (LOS) UWB ranging applications,” by Z. N. Low, J. H. Cheong, C. L. Law, W. T. Ng, and Y. J. Lee, in IEEE Antennas Wireless Propagat. Lett., vol. 4, pp. 63-67, 2005. Analytical expressions for critical design parameters (e.g., bias and MSE) of a TOA estimator in the non-asymptotic regions (i.e., low SNR regions) have not been investigated in detail. Very few analytical studies have been carried out on the bias or the MSE under different applications or conditions. Some examples are (a) “Large and small error performance limits for multipath time delay estimation,” by J. P. lanniello, in IEEE Trans. Acoust., Speech, Signal Processing, vol. ASSP-34, no. 2, pp. 245-251, April 1986; (b) “Threshold region performance of maximum likelihood direction of arrival estimators,” by F. Athley, in IEEE Trans. Signal Processing, vol. 53, no. 4, pp. 1359-1373, April 2005; and (c) “A lower bound for the error-variance of maximum-likelihood delay estimates of discontinuous pulse waveforms,” by K. L. Kosbar and A. Polydoros, in IEEE Trans. Inform. Theory, vol. 38, no. 2, pp. 451-457, March 1992. In the article “Large error performance of UWB ranging in multipath and multiuser environments,” by J.-Y. Lee and S. Yoo, in IEEE Trans. Microwave Theory Tech., vol. 54, no. 4, pp. 1887-1985, June 2006, the bounds on the variance of the large errors are derived and the TOA estimation performance is evaluated by simulation.

### SUMMARY

An optimum threshold selection method for generic TOA estimators varies adaptively according to channel conditions (e.g., SNRs). According to one embodiment of the present invention, one technique adaptively relates the estimator bias and MSE to the SNR to determine a threshold value. This technique reduces ranging error under practically all channel conditions.

A method under the present invention is generic and system-independent, applicable to both coherent and non-coherent receivers. The method also provides a unified performance analysis to both MF and ED threshold-based TOA estimators for UWB signals, even in the presence of dense multipaths. The method accounts for the effects of both small and large estimation errors, providing an analytical methodology for use under the dense multipath UWB condition. In particular, the method evaluates both the bias and the MSE of the estimation as a function of SNR under various operating conditions, thereby overcoming the limitation of conventional asymptotic analysis, which is valid only under a high SNR condition.

The present invention identifies the criteria for optimally selecting a threshold—which minimizes the MSE—to guide efficient estimator design. In the detailed description below, analytical results according to the present invention have been validated by Monte Carlo simulations using the IEEE 802.15.4a channel models. The MSE of the estimator has also been compared to conventional CRLB and an improved Ziv-Zakai lower bound¹, highlighting the strong influence of large errors on the estimation performance. A comparison between the performance losses faced by ED-based estimators and MF-based estimators is carried out to determine the tradeoff for lower implementation complexity. ¹The improved Ziv-Zakai lower bound is described, for example, in the article “Improved lower bounds on time-of-arrival estimation error in realistic UWB channels,” by D. Dardari, C.-C. Chong, and M. Z. Win, in Proc. IEEE Int. Conf. on Ultra-Wideband (ICUWB), Waltham, Mass., September 2006, pp. 531-537.

The present invention is better understood upon consideration of the detailed description below and the accompanying drawings.

### BRIEF DESCRIPTION OF THE DRAWINGS

FIG. 1 shows a multipath channel power delay profile (PDP) under a line-of-sight (LOS) condition in which a received signal at the TOA estimator has a high SNR.

FIG. 2 shows a multipath PDP based on a LOS channel in the IEEE 802.15.4a standard channel model.

FIG. 3 shows a multipath channel PDP under a NLOS condition in which the received signals at the TOA estimators have low SNRs.

FIG. 4 shows a multipath PDP based on an NLOS channel in the IEEE 802.15.4a standard channel model

FIG. 5 shows circuit 500, which is a coherent system that estimates a TOA based on MF.

FIG. 6 shows circuit 600, which is a non-coherent system that estimates a TOA based on ED.

FIG. 7 shows received signal r(t) at the output terminal 504 of BPF 502, using an IEEE 802.15.4a standard channel model under a LOS condition.

FIG. 8 shows received signal r(t) at the output terminal 504 of BPF 502, using an IEEE 802.15.4a standard channel model under a NLOS condition.

FIG. 9 shows signal u(t) at output terminal 508 of MF 506 for a coherent receiver under the LOS condition in the IEEE 802.15.4a standard channel model.

FIG. 10 shows signal u(t) at output terminal 508 of MF 506 for a coherent receiver under the NLOS condition in the IEEE 802.15.4a standard channel model.

FIG. 11 shows signal v(t) at output terminal 512 of square law device (SLD) 510 for a coherent receiver under the LOS condition in the IEEE 802.15.4a standard channel model.

FIG. 12 shows signal v(t) at output terminal 512 of SLD 510 for a coherent receiver under the NLOS condition in the IEEE 802.15.4a standard channel model.

FIG. 13 shows signal vₖ at output terminal 612 of ED 606 for a non-coherent receiver under the LOS condition in the IEEE 802.15.4a standard channel model.

FIG. 14 shows signal vₖ at output terminal 612 of ED 606 for a non-coherent receiver under the NLOS condition in the IEEE 802.15.4a standard channel model.

FIG. 15 is a flow chart showing the operations of threshold-based TOA estimator 1500.

FIG. 16 shows a multipath PDP observation time being divided into

$$N = \frac{T}{{t}_{s}}$$

time slots.

### DETAILED DESCRIPTION OF THE PREFERRED EMBODIMENTS

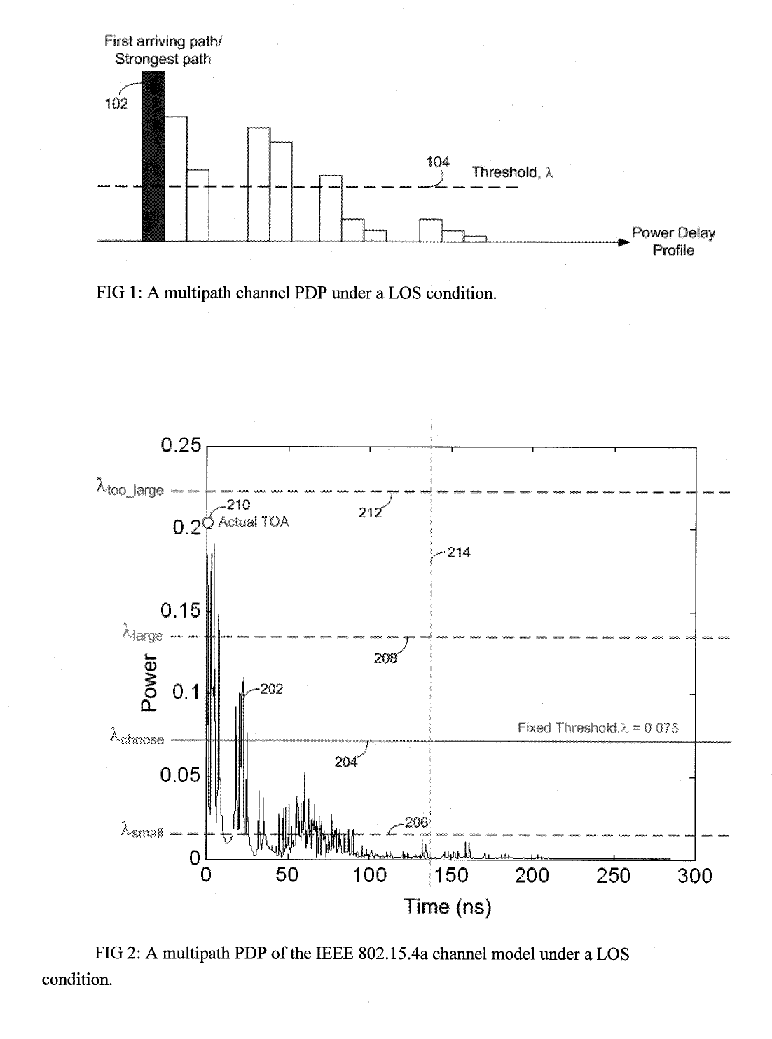

In a multipath channel, the TOA of the signal corresponding to the first arriving path is difficult to identify, especially under a low SNR condition. FIG. 1 shows a multipath channel PDP under a LOS condition in which received signals at the TOA estimator has high SNRs. Under such a channel condition, the first arriving path 102 is usually also the strongest signal (“strongest path”). Therefore, setting the threshold value (λ) 104 under this condition is straightforward.

FIG. 2 shows a multipath PDP based on a LOS channel from the IEEE 802.15.4a standard channel model². In FIG. 2, threshold 204 (i.e., λ_{choose}), which allows a TOA estimation of LOS PDP 202, may be set within a large dynamic range (i.e., from threshold 206 (λₛₘₐₗₗ) to threshold 208 (λ_{large})) without compromising the ability to determine actual TOA 210 accurately. However, if the threshold is set to be too high (e.g., threshold 212 (λₜₒₒ_{_{—}}_{large})), an actual TOA cannot be estimated. In that event, the estimated TOA is chosen based on a missing path strategy, which is usually set as the maximum peak (which happens to be the actual TOA 210 in this example) or the mid-point of the observation time 214. ²“A comprehensive standardized model for ultrawideband propagation channels,” by A. F. Molisch, D. Cassioli, C.-C. Chong, S. Emami, A. Fort, B. Kannan, J. Karedal, J. Kunisch, H. Schantz, K. Siwiak, and M. Z. Win, in IEEE Trans. Antennas Propagat., vol. 54, no. 11, pp. 3151-3166, November 2006.

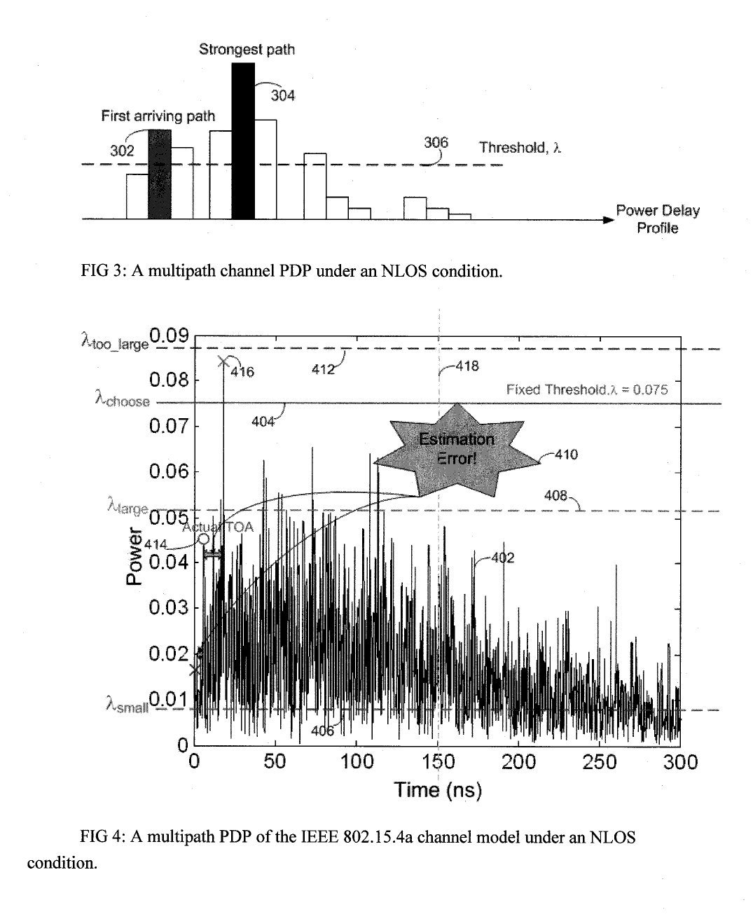

FIG. 3 shows a multipath channel PDP under a NLOS condition in which the received signals at the TOA estimator has low SNRs. Under that channel condition, first arriving path 302 received is usually not the strongest path. (In this description, the term “first arriving path” refers to the portion of the signal which appears to have the least delay). Typically, and as shown in FIG. 3, strongest path 304 arrives later because of multiple reflections, diffractions and delays introduced as the signal propagates through materials. Therefore, setting the threshold value (λ) 306 under this condition is less straightforward.

FIG. 4 shows a multipath PDP based on an NLOS channel from the IEEE 802.15.4a standard channel model³. In this example, unlike the example of FIG. 2, threshold 404 (i.e., λ_{choose}) for NLOS PDP 402 can be set only within a relatively narrow region. If the threshold λ is set too small (e.g., threshold 406 (λₛₘₐₗₗ)), a high false-alarm probability may result from noise (e.g., an early TOA estimation). Conversely, if the threshold λ is set to too large (e.g., threshold 408 (λ_{large})), a lower detection probability and a higher probability of choosing an erroneous path (e.g., a late TOA estimation) due to fading may result. In either case, estimation error 410 degrades accuracy in the ranging process. Furthermore, if the threshold λ is set too large (e.g., threshold 412 (λₜₒₒ_{_{—}}_{large})), actual TOA 414 cannot be estimated. In that case, the TOA is estimated based on a missing path strategy (i.e., using either the maximum peak 416, or the mid-point of the observation time, 418). In either case, the actual TOA 414 cannot be estimated and estimation error 410 occurs. ³Id.

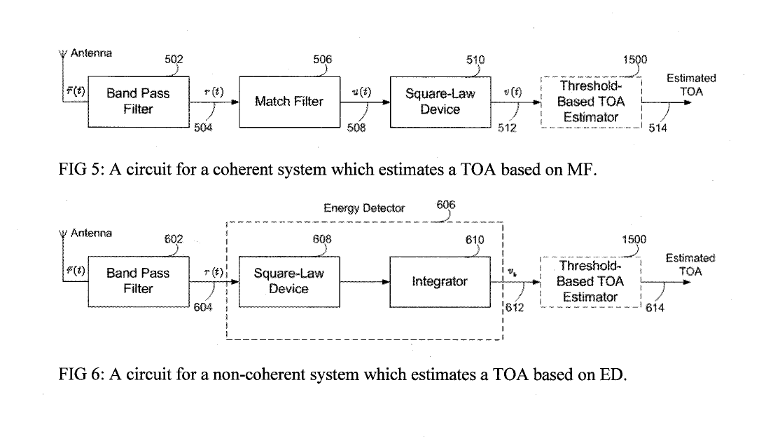

The threshold value λ for a threshold-based TOA estimator must be carefully selected to achieve an optimum design of the threshold-based TOA estimator. FIGS. 5 and 6 show circuits 500 and 600, which represent coherent and non-coherent systems that estimate TOAs based on MF and ED, respectively. As shown in FIG. 5, receives signal r(t) at terminal 504 of BPF 502 is correlated with a local template to generate a cross-correlation function u(t) at output terminal 508 of MF 506. A time interval during which the first arriving path is observed may be detected from function v(t) at output terminal 512 of SLD 510, which follows MF 506 to remove sign ambiguity in the signal amplitude. Output v(t) at terminal 512 of SLD 510 is provided to threshold-based TOA estimator 1500 to estimate the TOA 514 of the received signal.

FIG. 6 shows circuit 600, which is a non-coherent system for estimating TOA based on ED. As shown in FIG. 6, received signal r(t) at terminal 604 (after filtering by BPF 602) is fed into ED 606, which includes SLD 608, and integrator 610. Output vₖ at terminal 612 of ED 606 is compared with the threshold set in threshold-based TOA estimator 1500. The time of the first threshold crossing event is taken to be estimated TOA 614 for received signal r(t).

Consider a pulse p(t) of duration Tₚ and energy Eₚ transmitted through a multipath channel. Received signal r(t) at output terminal 504 or 604 of BPF 502 or 602 may be represented by:

r(t)=s(t)+n(t), (1)

where signal s(t) may be represented by the sum of attenuated and delayed pulses:

$$s ( t ) = {\sum }_{l = 1}^{L} {α}_{l} p ( t - {τ}_{l} ) , \qquad ( 2 )$$

and where n(t) is AWGN with a zero mean and a two-sided power spectral density N₀/2, L is the maximum number of MPCs, τ₁=τ is the TOA to be estimated based on the received signal r(t) observed over the interval [0,T), and {τ₂, τ₃, . . . , τ_{L}; α₁, α₂, . . . , α_{L}} is a set of nuisance parameters including path gains, αₗ's and delays τₗ's. The channel may be modeled as a tapped delay line where τₗ=τ+Δ(l−1), Δ≈Tₚ is the width of a resolvable time slot and Δ(L−1) is the dispersion of the channel. Path gain α₁ may be given generally by αₗ=bₗβₗe^{iφ}^{ₗ}, where ⊖ₗ and φₗ denote the path's amplitude and phase, respectively, and bₗ is a random variable which may take the value ‘1’ (for path present) and the value ‘0’ (for path absent), with probabilities p_{b} and 1−p_{b}.

The present invention provides an estimation of the TOA (τ) of the direct path, when exists, by assuming that τ is uniformly distributed in the interval [0,Tₐ), for Tₐ<T. However, the received signal depends on the nuisance parameters that, due to noise and fading, can strongly affect the TOA estimation. For a high SNR value, while the dominant peaks correspond to signal echoes, finding the correct peak in the presence of noise and fading is not straightforward. The ambiguity highlights that TOA estimation in a multipath environment is not purely a parameter estimation problem, but rather a joint detection-estimation problem.

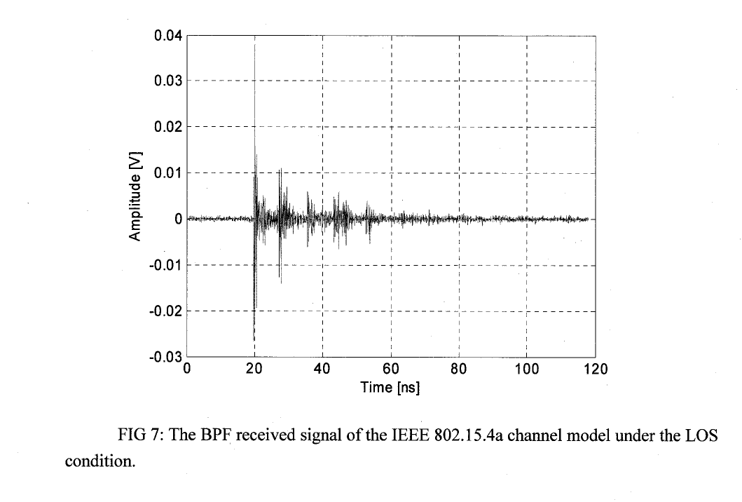

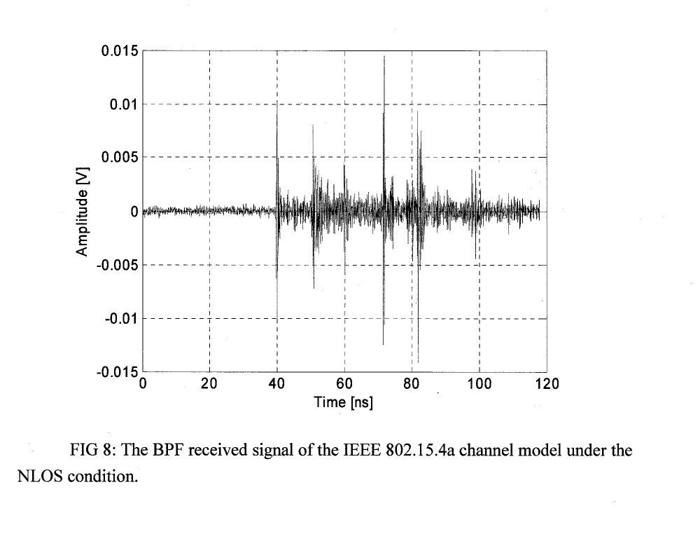

FIG. 7 shows received signal r(t) at the output terminal 504 of BPF 502, using an IEEE 802.15.4a standard channel model under a LOS condition. Similarly, FIG. 8 shows received signal r(t) at the output terminal 504 of BPF 502, using an IEEE 802.15.4a standard channel model under a NLOS condition.

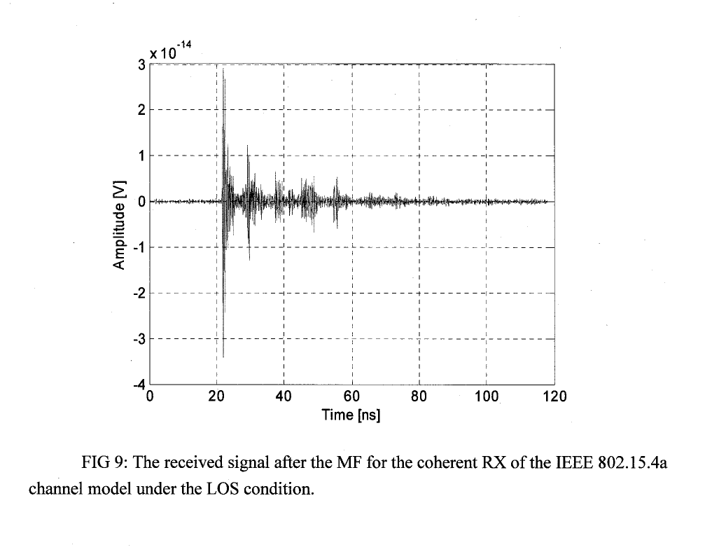

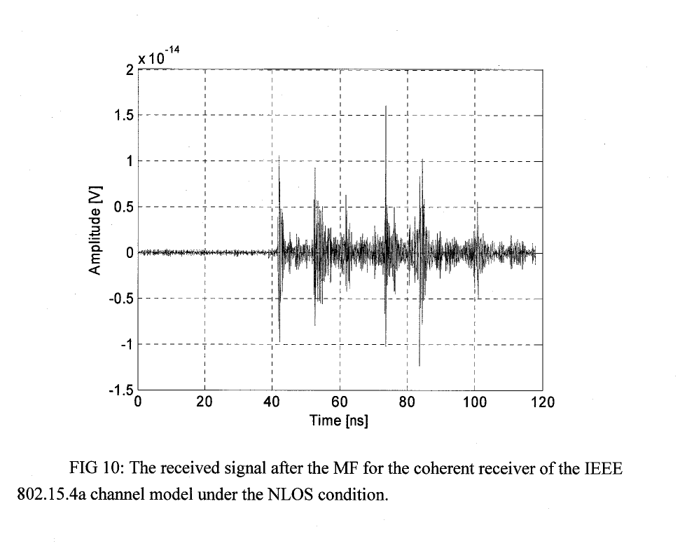

FIG. 9 shows signal u(t) at output terminal 508 of MF 506 for a coherent receiver under the LOS condition in the IEEE 802.15.4a standard channel model. Similarly, FIG. 10 shows signal u(t) at output terminal 508 of MF 506 for a coherent receiver under the NLOS condition in the IEEE 802.15.4a standard channel model

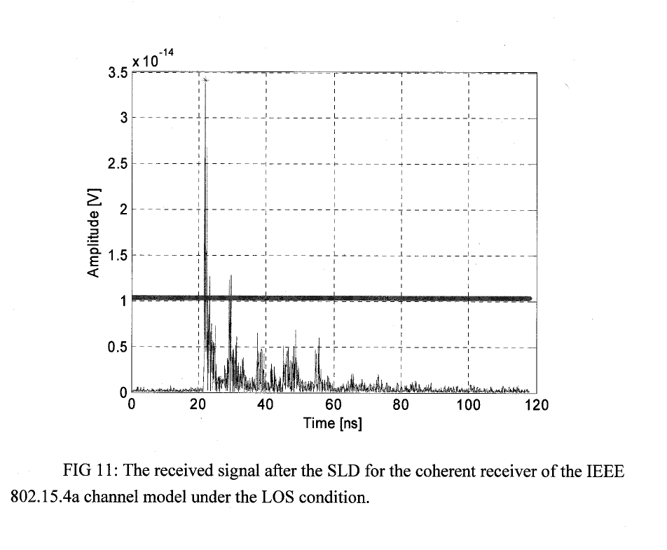

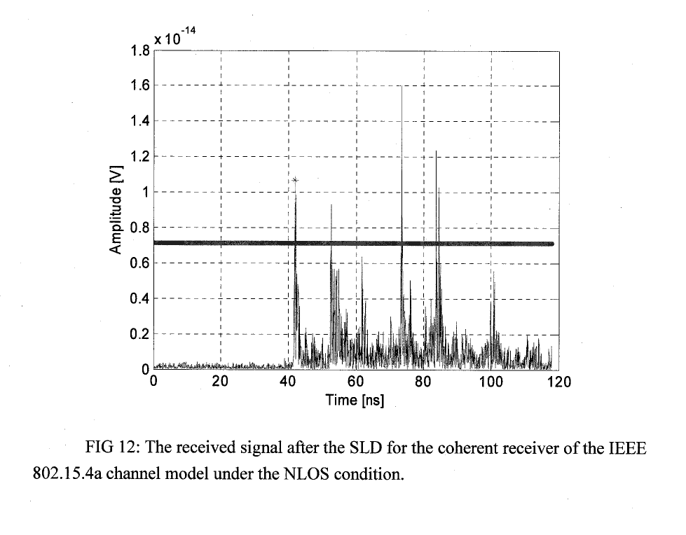

FIG. 11 shows signal v(t) at output terminal 512 of SLD 510 for a coherent receiver under the LOS condition in the IEEE 802.15.4a standard channel model. Similarly, FIG. 12 shows signal v(t) at output terminal 512 of SLD 510 for a coherent receiver under the NLOS condition in the IEEE 802.15.4a standard channel model.

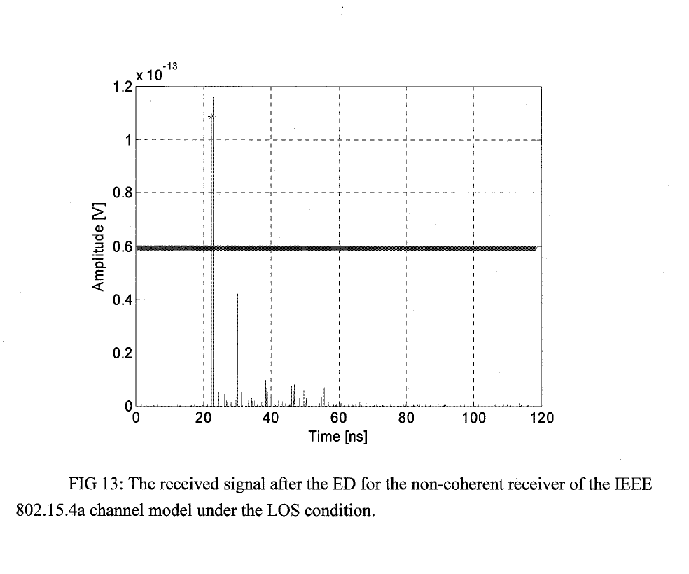

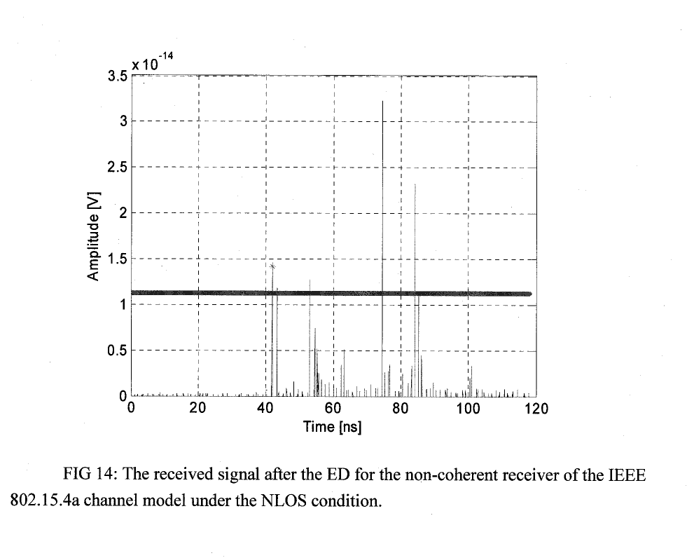

FIG. 13 shows signal vₖ at output terminal 612 of ED 606 for a non-coherent receiver under the LOS condition in the IEEE 802.15.4a standard channel model. Similarly, FIG. 14 shows signal Vk at output terminal 612 of ED 606 for a non-coherent receiver under the NLOS condition in the IEEE 802.15.4a standard channel model.

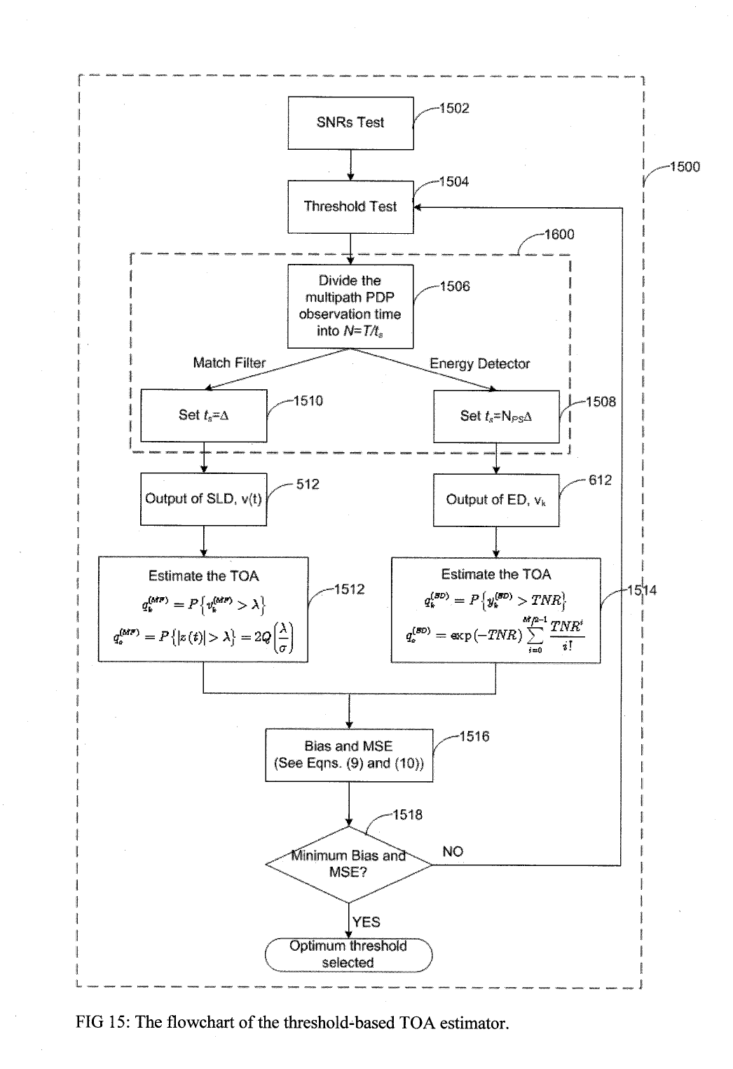

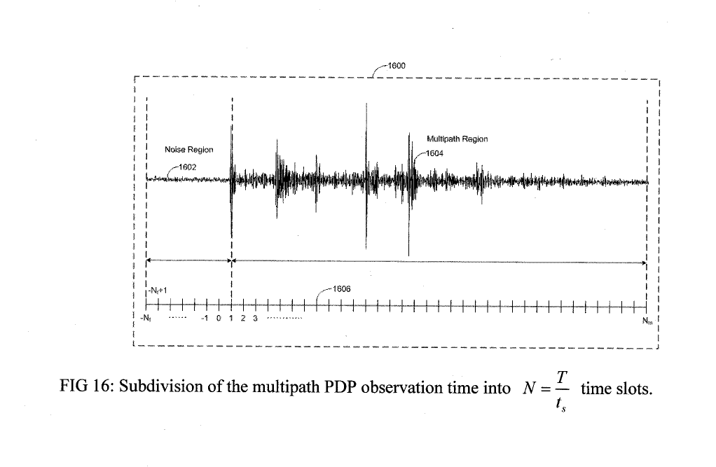

To select an optimum threshold value for threshold-based TOA estimator 1500 (shown, for example, in either of FIGS. 5 and 6), the bias and the MSE are minimized. FIG. 15 is a flowchart showing the threshold value selection operations in threshold-based TOA estimator 1500. At step 1502, after calculating SNRs of the received signals at the receiver, an initial threshold value is set at step 1504. Then, at step 1506, an observation interval is subdivided into N=T/tₛ slots each of duration tₛ. Step 1506 is illustrated, for example, in FIG. 16, where a multipath PDP observation time period is divided into N=T/tₛ time slots. For the ED estimator (e.g., circuit 600), the slot interval corresponds to an integration time and a sampling period tₛ at the output of integrator 610, which may be a sub-Nyquist sampled system. According to one embodiment, at step 1508, slot interval tₛ=N_{PS}Δ, where N_{PS} is the number of potential paths per slot. The number of time slots containing MPCs is thus given by N_{P}=L/N_{PS}. For the MF estimator, the observation interval may be divided at step 1510 into N slots of slot interval tₛ=Δ.

As shown in FIG. 16, the interval

$$[ 0 , τ - \frac{{t}_{s}}{2} ] ,$$

corresponding to the first

$${N}_{f} = \frac{τ}{{t}_{s}}$$

slots, which contain only noise signal (i.e., noise region 1602). The interval

$$[ τ - \frac{{t}_{s}}{2} , T ] ,$$

corresponding to the remaining Nₘ=N−N_{f} slots, may contain, in addition to the noise, dense multipath echoes (i.e., multipath region 1604). In FIG. 16, the slots in the multipath region are number 1, 2, 3, . . . , Nₘ, while the slots in the noise region are numbered −N_{f}+1, −N_{f}+2, . . . , −1, 0. The true TOA τ is falls on slot 1, which is located after n_{TOA}=N_{f} slots from the beginning of observation interval 1606. Since τ is uniformly distributed in the interval [0,Tₐ], the random variable n_{TOA} is uniformly distributed in the interval [0,N_{TOA}−1], where

$${N}_{TOA} = \frac{{T}_{a}}{{t}_{s}} .$$

For the MF estimator, output v^{(MF)}(t) at output terminal 512 may be written as

$${v}^{( MF )} ( t ) = \vert {\sum }_{l = 1}^{L} {α}_{l} {Φ}_{p} ( t - {τ}_{l} ) + z ( t ) \vert , \qquad ( 3 )$$

where Φₚ(τ) is the autocorrelation function of the pulse p(t), and z(t) is the colored Gaussian noise at the output terminal of MF 506, with an autocorrelation function given by

$${Φ}_{z} ( τ ) = {N}_{0} \frac{{Φ}_{p} ( τ )}{2} .$$

### Since tₛ=Δ for an MF-based estimator, Nₚ=L (i.e., no more than one path is present within each slot in the multipath region).

To estimate the TOA in an MF-based estimator, at step 1512, the probability qₖ^{(MF)}, which represents the probability that the modulus vₖ^{(MF)} of the MF output v^{(MF)}(t) exceeds the threshold λ at time τₖ, is given by:

qₖ^{(MF)}=P{vₖ^{(MF)}>λ} for 1≦k≦Nₚ, (4)

where vₖ^{(MF)}=v^{(MF)}(tₖ).

While, in the noise region, the probability q₀^{(MF)} that vₖ^{(MF)} (which consists only of noise component z(t)) exceeds threshold λ is given by

$${q}_{0}^{( MF )} = P \{ \vert z ( t ) \vert > λ \} = 2 Q ( \frac{λ}{σ} ) , \qquad ( 5 )$$

where

$${σ}^{2} = \frac{{Φ}_{p} ( 0 ) {N}_{0}}{2} = \frac{{E}_{p} {N}_{0}}{2}$$

and Q(·) is the Gaussian probability integral. These probabilities, except q₀, depend on the specific channel model. For example, based on the IEEE 802.15.4a standard channel model, the lth path amplitude βₗ is a Nakagami-m random variable with parameters mₗ (fading parameter, mₗ≧0.5) and E{βₗ²}=Λₗ. The phase φₗ can take the values {0,2π} with equal probability. These channel information can be input into equation (3). The probability qₖ^{(MF)} given in equation (4) can then be calculated based on (3).

For an ED-based estimator, the sampled outputs vₖ^{(ED)} at output terminal 612, at each time slot k, is given by:

$${v}_{k}^{( ED )} = {\int }_{( k - 1 + {n}_{TOA} ) {t}_{s}}^{( k + {n}_{TOA} ) {t}_{s}} {\vert r ( t ) \vert}^{2} d t for k = - {N}_{f} + 1 , … , {N}_{m} . \qquad ( 6 )$$

To estimate the TOA for an ED-based estimator, at step 1514, the probability qₖ^{(ED)} that output vₖ^{(ED)} at the output terminal 612 of ED 606 exceeds threshold λ at time τₖ, is given by:

qₖ^{(ED)}=P{vₖ^{(ED)}>λ}=P{yₖ^{(ED)}>TNR}, (7)

where yₖ^{(ED)} and TNR (“threshold-to-noise ratio”) are defined by

$${y}_{k}^{( ED )} = \frac{{v}_{k}^{( ED )}}{{N}_{0}} and TNR = \frac{λ}{{N}_{0}} .$$

In the noise region, the probability q₀^{(ED)} that the noise exceeds threshold λ is given by

$${q}_{0}^{( ED )} = {e}^{- TNR} {\sum }_{i = 0}^{\frac{M}{2} - 1} \frac{{( TNR )}^{i}}{i !} , \qquad ( 8 )$$

with M is the degrees of freedom.

In the subsequent steps 1516-1518, the probability qₖ represents the applicable one of qₖ^{(MF)} and qₖ^{(ED)}. In step 1516, the bias and the MSE may be calculated as follows:

$$\begin{matrix}BIAS = E \{ BIAS {\vert}_{{n}_{TOA}} \} = {t}_{s} [ \frac{1}{{q}_{o}} + \frac{{( 1 - {q}_{o} )}^{{N}_{TOA} + 1} - 1 + {q}_{o}}{{N}_{TOA} {q}_{o}^{2}} - \frac{1 + {N}_{TOA}}{2} ] + \frac{[ 1 - {( 1 - {q}_{o} )}^{{N}_{TOA}} ]}{{N}_{TOA} {q}_{o}} {\sum }_{n = 2}^{P} ( n - 1 ) {t}_{s} {q}_{n} {\prod }_{k = 1}^{n - 1} ( 1 - {q}_{k} ) , & ( 9 ) \\ MSE = E \{ MSE {\vert}_{{n}_{TOA}} \} = {t}_{s}^{2} [ \frac{( {( 1 - {q}_{o} )}^{{N}_{TOA}} - 1 ) ( 2 + {q}_{o} ( {q}_{o} - 3 ) )}{{N}_{TOA} {q}_{o}^{3}} + \frac{3 {N}_{TOA} {q}_{o} ( {q}_{o} - 2 ) + 2 {N}_{TOA}^{2} {q}_{o}^{2} + {q}_{o} ( {q}_{o} - 12 ) + 12}{6 {q}_{o}^{2}} ] + \frac{[ 1 - {( 1 - {q}_{o} )}^{{N}_{TOA}} ]}{{N}_{TOA} {q}_{o}} \{ {q}_{1} η + {\sum }_{n = 2}^{P} {( n - 1 )}^{2} {t}_{s}^{2} {q}_{n} {\prod }_{k = 1}^{n - 1} ( 1 - {q}_{k} ) + \frac{{T}_{a}}{12} {\prod }_{k = 1}^{P} ( 1 - {q}_{k} ) \} , & ( 10 )\end{matrix}$$

where η=CRLB and

$$η = \frac{{t}_{s}^{2}}{12}$$

for the MF-based and the ED-based estimators, respectively. These values for the bias and MSE are then evaluated at step 1518 to determine if they fall within a range of minimum bias and MSE values set by the designer of the system. If these bias and MSE values meet the minimum value criteria, the threshold λ is deemed optimal. Threshold selection is then deemed complete. Otherwise, the threshold selection process returns to step 1504, where a different threshold value λ′ is assigned.

Because the threshold value selected using the method of the present invention depends on the channel condition (e.g., SNR's), the threshold value selected for the TOA estimator vary adaptively according to the channel condition. Also, the selected threshold value also minimizes ranging error (i.e., bias and MSE) as a function of the SNRs. Therefore, the present invention may be implemented in ad-hoc sensor networks and mobile terminals that required frequent updates in the current channel conditions. Further, the method of the present invention is also generic and system-independent, applicable to both coherent transceivers (e.g., MF-based transceivers) and non-coherent transceivers (e.g., ED-based transceivers), even in the presence of dense multipath. As discussed above, the difference in performance loss between an ED-based TOA estimator and an MF-based TOA estimator is significant only under low SNR conditions. Under a high SNR condition, the ED-based TOA estimator works sufficiently well. Therefore, the present invention allows a system designer to use a lower complexity implementation under specific channel conditions.

Further, the TOA estimation procedure according to the present invention may be subdivided into a coarse estimation phase and a fine estimation phase. To realize a highly accurate ranging system (e.g., military applications), both coarse and fine estimations may be required by the TOA estimators. Alternatively, for a lower-cost product requiring less accurate ranging (e.g., a consumer product), the coarse estimation phase may be sufficient. Therefore, the present invention also provides flexibility to the system designers in choosing a TOA estimation scheme for the system. The present invention is applicable to cellular systems, wireless local area networks, wireless sensor networks, and any other wireless system where a threshold-based TOA estimator for ranging or localization is used. To best identify the first arriving path, a UWB system is preferred over a narrowband system.

The detailed description above is provided to illustrate specific embodiments of the present invention and is not intended to be limiting. Numerous variations and modifications within the scope of the present invention are possible. The present invention is set forth in the following claims.

We claim:

1. A method for selecting a threshold value for a time-of-arrival (TOA) estimator for a signal propagated through a communication channel, comprising:
(i) determining a metric that represents a condition of the communication channel;
(ii) selecting an initial value for a current threshold value based on the metric;
(iii) dividing an observation period in the channel into a number of time slots, based upon identification of a number of candidate events in a power delay profile within the observation period;
(iv) computing (a) for each candidate event, the probability that a signal detection function of the signal evaluated at that candidate event exceeds the current threshold; and (b) the probability that the signal detection function exceeds the current threshold prior to the first of the candidate events;
(v) based on the computed probabilities, computing a bias value and a mean-square-error value;
(vi) determining if the bias value the mean-square-error value meet a predetermined set of criteria;
(vii) when the predetermined set of criteria are not met, revising the current threshold value according to the metric and repeating steps (iii)-(vii); and
(viii) selecting the current threshold value as the threshold value for the TOA estimator.

2. A method as in claim 1, wherein the metric comprises a signal to noise ratio.

3. A method as in claim 1, wherein the number of time slots depends in part on a signal sampling rate.

4. A method as in claim 3, wherein the signal sampling rate is a function of a root mean-square delay spread in the communication channel.

5. A method as in claim 1, wherein the predetermined set of criteria comprises the criterion that the computed bias is within a predetermined value from a minimum bias value.

6. A method as in claim 1, wherein the predetermined set of criteria comprises the criterion that the computed mean-square-error value is within a predetermined value from a minimum mean-square-error value.

7. A method as in claim 1, wherein multiple echoes of the signal may arrive within a time slot.

8. A method as in claim 1, wherein the signal detection function is an autocorrelation function.

9. A method as in claim 1, wherein the signal detection function comprises an integral of a function of the signal over a time period between successive candidate events.

10. A method as in claim 1, wherein the first candidate event occurs at an estimated time-of-arrival of the signal by a direct path.

11. A method as in claim 1, wherein a probability distribution representing a time-of-arrival of the signal by a direct path is uniform.

12. A method as in claim 1, wherein the TOA estimator operates in the context of a coherent receiver estimator.

13. A method as in claim 12, wherein the probability of the signal detection function exceeding the current threshold prior to the first candidate event is computed based on the a colored Gaussian noise model.

14. A method as in claim 12, wherein the coherent receiver estimator comprises a match filter.

15. A method as in claim 1, wherein the TOA estimator operates in the context of an energy detector estimator.

16. A method as in claim 15, wherein the probability of the signal detection function exceeding the current threshold value prior to the first candidate event is computed based on a Poisson distribution.

17. A method as in claim 16, wherein the Poisson distribution includes as an inter-arrival time parameter a threshold-to-noise ratio.

18. A method as in claim 1, further comprising the step of accepting as a TOA the time at which the signal detection function exceeds the selected threshold value for the TOA estimator.

19. A method as in claim 1, wherein the TOA estimator comprises a two-step TOA determination process, wherein a coarse TOA determination step provides a result that is used in a subsequent fine TOA determination step.

20. The method as in claim 1, wherein the TOA estimator includes a multipath channel power delay profile.

21. The method as in claim 20, further comprising dividing the observation time T into N time slots, each having a duration of tₛ, being the duration between successive signal samples.

22. The method as in claim 1, further comprising adaptively updating the threshold value according to the metric.

23. The method as in claim 22, wherein the metric is applicable to both low SNR and high SNR channel conditions.

24. The method as in claim 1, the method being applicable to both coherent and non-coherent transceivers.

25. The method as in claim 1, wherein an estimated time-of-arrival corresponds to the first arriving path.

26. The method as in claim 25, wherein the first arriving path does not correspond to the strongest path.

27. The method as in claim 1, the method being applicable to both line-of-sight (LOS) and non-LOS (NLOS) conditions.
